(19) United States
(12) Patent Application Publication
(10) Pub. No.: US 2001/0039506 A1
(43) Pub. Date: Nov. 8, 2001

(54) Process for automated real estate valuation

(76) Inventor: Michael L. Robbins, Belgium, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/825,642

(22) Filed: Apr. 4, 2001

Related U.S. Application Data
(60) Provisional application No. 60/194,543, filed on Apr. 4, 2000.

(51) Int. Cl. G06F 17/60

(52) U.S. Cl. 705/10

(57) ABSTRACT

A real estate appraisal method wherein a database of enhanced records of properties in a the same territory as the subject property is used to derive market-driven value adjustment rates for property attributes and time differentials. The adjustment rates are applied to the properties in the database, the most similar comparable properties are selected on the basis of similarity in property attributes and the market value is then estimated from the selected most similar comparable properties. The resulting valuation is supportable by market conditions and can be printed on specified forms.

### CROSS-REFERENCE TO RELATED APPLICATION

This application claims the benefit of U.S. Provisional Application No. 60/194,543 filed Apr. 4, 2000.

### FIELD OF THE INVENTION

This invention relates generally to real estate appraisals and more particularly to a process for estimating the value of real property through the application of the sales comparison approach.

### BACKGROUND OF THE INVENTION

Real estate appraisals are generally used to estimate the market value of a real property interest in real estate. Real estate appraisals are useful and necessary in many types of real estate transactions. However, a problem with real estate appraisal is that they require considerable effort and time to perform, are relatively expensive, difficult to review, and prone to error (it is not uncommon for three appraisers independently appraising the same property to be more than 20% apart in their final estimate of value).

Typically, an appraiser is required to inspect the subject property to be appraised and determine the property's market value. In order to estimate the market value, the real estate appraiser attempts to find recent sales that could be construed as reasonable substitutes for the subject property. The most relevant units of comparison (as determined from market behavior) are determined from the comparables. Next, the sale prices of the comparables are adjusted to reflect their differences from the subject property. The adjusted sale prices are then reconciled to the comparables in order to derive a single value estimate of the subject property, which is a reflection of the probable price that would be agreed upon between knowledgeable parties acting without duress in a competitive market. The process of appraisal typically takes several days to finish, which may be too long in many of today's fast paced real estate transactions.

In addition, the appraisal process does not provide much insight on how the comparable properties were selected, how the adjustment rates were determined, or most importantly how credible the analysis has been, all of which often results in estimates that do not support expected outcomes.

Automated valuation models (AVM) have been developed for use by appraisers.

U.S. Pat. No. 5,857,174 discloses a real estate appraisal method in which the buyer of a property assigns points to a subject property and each comparable property based upon an Ideal Point System (IPS). The points assigned, or IPS values, are based upon the desirability factors for each of five categories of criteria. The total possible IPS value for any property is 100, corresponding to 100 percent desirability. Once the buyer's IPS values are determined, the property may be subsequently used as a comparable property. The appraiser need only select a subject property and obtain IPS values for the subject property. The sales price of each comparable property is then adjusted based upon the relative difference between the IPS values for the comparable properties and the IPS values of the subject property, by dividing the total IPS value for each comparable property with the IPS value for the subject property to obtain a composite adjustment ratio. The adjustment ratio for each comparable property is then multiplied by the sales price to obtain an adjusted sales price. Any greatly divergent adjusted sales prices are discarded, and the average adjusted sales price is determined. The average adjusted sales price is used as the appraised value for the subject property.

U.S. Pat. No. 5,414,621 discloses a system and method for determining comparative values of comparable properties based on assessment percentages and sales data of the comparable properties to ultimately determine a value for a subject property. In a first embodiment, the “assessment percentage” is the “base property tax” for the subject property and comparable property. A price/tax factor is computed for each comparable property by dividing the sale (or sold) price of the comparable property by its base tax. The price/tax factor for each comparable property is then multiplied by the base tax of the subject property to generate a net comparative value for each comparable property. To take into account appreciation for recently sold comparable properties, an average appreciation is obtained for the area in which the subject and comparable properties are located. The average appreciation is pro rated to determine the comparative value for each comparable property. On the basis of the comparative values and other pertinent information, the value of the subject property may be set by a real estate agent, bank, appraiser, etc. In second and third embodiments, the “assessment percentage” is the “assessed value” and “phase value”, respectively, which are used to compute the comparative values in a manner similar to the first embodiment.

U.S. Pat. No. 6,058,369 discloses that by gathering information regarding the total number of sales, total number of pending listings, total number of active listings, and total number of expired listings in a time period, a market index may be derived. This market index can then be charted over a plurality of periods, giving an indication of any temporal trends. The market index can further be used to guide and determine the action of a service provider such as a lender or title insurance company in a proposed real estate transaction.

U.S. Pat. No. 6,178,406 B1 discloses a method for estimating the price of real property such as a single family residence. A set of real estate properties comparable to the subject property is retrieved. The comparable properties and the subject property are characterized by a plurality of common attributes each having a respective value. Each attribute value from the comparable properties are evaluated to the same attribute value of the subject property on a fuzzy preference scale indicating desirable and tolerable deviations from an ideal match with the subject property. A measurement of similarity between each comparable property and the subject property is then determined. Next, the price of the comparable properties are adjusted to the value of the subject property and the best properties are extracted for further consideration. The extracted comparable properties are then aggregated into an estimate price of the subject property.

U.S. Pat. No. 6,115,694 discloses a computer-implemented method for validating specified prices on real property. A set of real estate properties comparable to the subject property are retrieved. A measurement of similarity between each comparable property and the subject property is then determined. A plurality of adjustment rules are then applied to adjust the price of the comparable properties. The adjusted comparable properties are then extracted, sorted, and ranked, according to the specified sale price. The extracted comparable properties are then aggregated into an estimate price of the subject property. After aggregation, the estimate price of the subject property is compared to the specified price and a measurement of confidence validating the reliability of the specified price is then generated.

Typically, these known AVMs focus on providing an estimate of value that has been derived from a limited number of transactions through the analysis of property records (limited to parcel level inventories) of questionable quality. Even the AVMs that use large numbers of transactions use records of questionable quality and few specifics. Like the manual appraisal process, these AVMs do not provide much insight on how the comparable properties were selected, how the adjustment rates were determined, or most importantly how credible the analysis has been. Therefore, there is a need for a process that not only speeds up the appraisal production but also improves its overall quality.

### SUMMARY OF THE INVENTION

A hallmark of the current invention is a process to provide reasonable and accurate estimates of real estate market value. In one preferred embodiment, the invention is a method of determining an estimated value of a subject parcel of real estate, the method comprising the steps of:

A. constructing a valuation model based on the attributes by means of statistical analysis of a database comprising records for individual parcels of real estate, wherein the records comprise attributes of the individual parcels and wherein the parcels are not owner-occupied residential real estate;

B. determining a sale condition score for the individual parcels, wherein the sale condition score is based on the statistical fit of an actual recorded sales price for the individual parcel to a sales price predicted by the valuation model based on the individual parcel attributes; and,

C. adding the sale condition to the attributes recorded for the respective individual parcels.

In another preferred embodiment, the invention is a method of determining an estimated value of a subject parcel of real estate, the method comprising the steps of:

A. determining market derived attribute adjustment values by means of statistical analysis of a database comprising records for individual parcels of real estate, including the subject parcel, within a territory comprising the subject parcel, wherein the records comprise attributes of the individual parcels and wherein the parcels are not owner-occupied residential real estate; and

B. adjusting recorded actual sales prices for individual parcels by applying selected attribute adjustment values to the sales price, wherein the applied attribute adjustment values are selected based on a comparison of the attributes of the subject parcel and the attributes of the respective individual parcels.

In a further preferred embodiment, the invention is a method of determining an estimated value of a subject parcel of real estate, wherein the parcels are not owner-occupied residential real estate, the method comprising the step of compiling a database comprising enhanced records for substantially all of individual parcels of real estate in a territory which comprises the subject parcel, wherein the enhanced records comprise recorded attributes and derived attributes of the individual parcels.

In another preferred embodiment, the invention is a method for preparing a database of enhanced records for individual parcels of real estate, wherein the parcels are not owner-occupied residential real estate, the method comprising the steps:

A. identifying the individual parcels by the corresponding geocoding references;

B. correlating the individual parcels to their respective Census Tracts and Block Groups by means of the geocoding reference;

C. obtaining records for the individual parcels;

D. checking the records for errors and/or missing information;

E. correcting the records by replacing missing or incorrect values with statistically estimated values;

F. adding additional attributes to the records to create an enriched record file;

G. modeling the enriched record file to develop derived attributes for the individual parcels; and

H. adding the derived attributes to the records of the respective individual parcels.

In yet another preferred embodiment, the invention is a method of determining the estimated value of a subject parcel of real estate, wherein the parcels are not owner-occupied residential real estate, the method comprising the steps of:

A. providing a computer, wherein the computer is connected to at least one input device and at least one output device and is capable of accessing, reading and executing a real estate valuation software program;

B. inputing unique locational data corresponding to the parcel into the computer;

C. executing the real estate valuation software program to obtain at least one result based on the input data, the result being in the form of an estimated value for the parcel; and

D. communicating the value of the parcel obtained in Step C by means of the output device,

wherein the real estate valuation software program comprises computer readable and executable instructions for performing at least the following functions:

(i) compiling a database of records of individual parcels of real estate comprising the subject parcel, wherein the records comprise attributes of the individual parcels;

(ii) assigning appropriate geocodes to the individual parcels;

(iii) correlating the subject parcel and the comparable properties to respective Census Tracts and Census Blocks by means of the respective geocodes;

(iv) modeling the database to determine market-driven attribute adjustment values;

(v) selecting the most similar comparable properties, wherein the comparable properties are individual parcels having attributes similar to the subject parcel; and,

(vi) calculating an estimated value of the parcel on the basis of the selected comparable properties.

Another preferred embodiment, the invention is a real estate valuation apparatus comprising:

A. A computer operatively connected to at least one input device and at least one output device, and

B. a real estate valuation software program which executes at least the following functions:

(i) compiling a database of records of individual parcels of real estate comprising the subject parcel, wherein the records comprise attributes of the individual parcels and wherein the parcels are not owner-occupied residential real estate;

(ii) assigning appropriate geocodes to the individual parcels;

(iii) correlating the subject parcel and the comparable properties to respective Census Tracts and Census Blocks by means of the respective geocodes;

(iv) modeling the database to determine market-driven attribute adjustment values;

(v) selecting the most similar comparable properties, wherein the comparable properties are individual parcels having attributes similar to the subject parcel; and,

(vi) calculating an estimated value of the parcel on the basis of the selected comparable properties.

wherein the computer has access to and can execute the software program.

### BRIEF DESCRIPTION OF THE DRAWINGS

Preferred embodiments of the invention are described below with reference to the following accompanying drawings, which are for illustrative purposes only. Throughout the following views, reference numerals will be used in the drawings, and the same reference numerals will be used throughout the several views and in the description to indicate same or like parts.

FIG. 1 is a schematic showing typical internet communications between a computer and data sources in a preferred embodiment of the invention.

FIG. 2 is a block diagram flowchart showing steps for building a property attribute database usable in the invention.

FIG. 3 is a block diagram flowchart showing steps for applying the property attribute database shown in FIG. 2.

FIG. 4 a block diagram flowchart illustrating external data management for a preferred the embodiment of the invention.

FIG. 5 is a block diagram flowchart illustrating steps to derive the sale condition model for a preferred embodiment of the invention.

FIG. 6 is a block diagram flowchart illustrating steps to derive the attribute rules database for a preferred embodiment of the invention.

FIG. 7 is a block diagram flowchart illustrating the calibration steps for a preferred embodiment of the invention.

FIG. 8 is a block diagram flowchart illustrating the system control steps for a preferred embodiment of the invention.

FIG. 9 is a flowchart illustrating the process steps for estimating the value of the subject parcel for a preferred embodiment of the invention.

### DETAILED DESCRIPTION OF THE INVENTION

In the following detailed description, references made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be used and that structural, sequential and logical changes may be made without departing from the spirit and scope of the present invention. Specifically, while the following description frequently uses owner-occupied residential property for examples, one skilled in the art will recognize that the invention may be used for any type of real estate.

The term “parcel” refers to a specific plot of real estate, along with all improvements thereon, as identified by a street address or other locational identifier.

Geographic “areas”, “regions” and/or “territories” are any convenient subdivision of local land area. As such, they comprise any geographically based reference system (e.g., township/range and section, lot/block or the outline of an area traced on an aerial photograph, digital aerial photograph (including satellite images) or map (including GIS generated maps). Specific examples of such areas include, inter alia:

Census Geography—A collective term referring to the geographic entities used by the Census Bureau for data collection and tabulation. There is collection geography and tabulation geography.

Block—A geographic area bounded on all sides by visible or nonvisible features shown on census maps. A block is the smallest geographic entity for which the Census Bureau collects and tabulates decennial census information. See block boundary, block number, collection block, statistical entity, or tabulation block.

Block Group—A combination of census blocks that is a statistical subdivision of a census tract. Geographic block groups never cross census tracts but may cross the boundaries of county subdivisions, places, urbanized areas, voting districts, and so forth. Tabulation block groups may be split to present data for every unique combination of county subdivision, place, and the like.

Bourough—A county equivalent in Alaska, a minor civil division in New York, and an incorporated place in Connecticut, New Jersey, and Pennsylvania. See governmental unit.

Tract—Small, relatively permanent statistical subdivisions of counties delineated by local committees of census data users in accordance with Census Bureau guidelines for the purpose of collecting and presenting decennial census data. These neighborhoods contain between 1,000 and 8,000 people, typically approximately 1,700 housing units and 4,000 people. Tracts are designed to have homogeneous population characteristics, economic status, and living conditions at the time they are established. Census tract boundaries normally follow visible features but may follow governmental unit boundaries and other nonvisible features. There will be more than 60,000 census tracts in 2000. See statistical entity and census statistical areas committee.

Traffic analysis zone—An area defined by a metropolitan planning organization for tabulating transportation statistics from the census.

Consolidated metropolitan statistical area (CMSA)—A geographic entity designated by the federal Office of Management and Budget for use by federal statistical agencies. An area becomes a CMSA if it qualifies as a metropolitan statistical area (MSA), has a population of 1 million or more, and has component parts that qualify as primary metropolitan statistical areas, provided local opinion favors the designation. CMSA's consist of whole counties except for the new England states, where they consist of cities and towns.

Metropolitan statistical area—These are designated by the federal Office of Management and Budget for use by federal statistical agencies. These geographically based entities are a core area with a large population nucleus plus adjacent communities with a high degree of economic and social integration with the core. An MSA consists of one or more counties, except in New England, where MSAs are defined in terms of cities and towns; however, New England county metropolitan areas are defined in terms of counties. See consolidated metropolitan statistical area, metropolitan area, and statistical entity.

Census Metropolitan Area—A census metropolitan area (CMA) is a very large urban area (known as the urban core) together with adjacent urban and rural areas (known as urban and rural fringes) that have a high degree of social and economic integration with the urban core. A CMA has an urban core population of at least 100,000, based on the previous census. Once an area becomes a CMA, it is retained as a CMA even if the population of its urban core declines below 100,000. All CMAs are subdivided into census tracts. A CMA may be consolidated with adjacent census agglomerations (CAs) if they are socially and economically integrated. This new grouping is known as a consolidated CMA and the component CMA and CA(s) are known as the primary census metropolitan area (PCMA) and primary census agglomeration(s) [PCA(s)]. A CMA may not be consolidated with another CMA.

The above area definitions are in use in the U.S. Other countries have similar areas under a variety of names, but one skilled in the art will recognize an appropriate area regardless of its name.

A “comparable transaction” is a parcel, preferably a parcel other than the parcel being evaluated, which was transferred from one owner to another in an “arms-length” sale. An arm's length sale is a transaction freely arrived at in the open market, unaffected by abnormal pressure or by the absence of normal competitive negotiation as might be true in the case between related parties.

The invention is a process designed to assist the valuation professional (primarily a real estate appraiser) in the determination of a real estate parcel's market value through the application of the Sales Comparison Approach to value. The invention is designed such that the resulting value estimate is; (1) reasonably accurate, unbiased, and a direct extension of prior market behavior; (2) supportable by the professional appraiser through its design and implementation of the designated rules of appraisal; (3) believable by the appraiser's clients due to its tie to direct market evidence that can be reviewed and checked.

The market value estimation of a specific subject property by a professional appraiser demands a highly specified attribute profile, one that is more highly specified than that generally used for tax assessment purposes. Tax assessment is faced with treating all properties equally or consistently, regardless of how unfairly. In addition, the assessor has considerable political concerns to deal with, such as neighbor-to-neighbor value comparisons and budget limitations. The appraiser is faced with providing an accurate, supportable, and believable market value estimate of what the subject property will likely sell for on a given day.

“Market Value” is defined as the most probable price which a property should bring in a competitive and open market under all conditions requisite to a fair sale, the buyer and seller each acting prudently and knowledgeably, and assuming the price is not affected by undue stimulus. Implicit in this definition is the consummation of a sale as of a specified date and the passing of title from seller to buyer under conditions whereby: (1) both parties are well informed or well advised, are typically motivated and are acting in what they consider their own best interests; (2) a reasonable time is allowed for exposure in the open market; and (3) payment is made in terms of cash in U.S. dollars (or in terms of financial arrangements comparable thereto) and the price represents the normal consideration for the property sold unaffected by special or creative financing or sales concessions granted by anyone associated with the sale.

An “appraisal” is an opinion of value. Although it is an impartial, expert, and reasoned conclusion formed by a trained professional based on an analysis of all relevant evidence, it is still an opinion. It represents the appraiser's perception of the most likely, most probable price available in an arm's-length transaction for the appraised interest subject to the qualifying conditions imposed. It is the intent of this invention to assist the appraiser in their efforts by efficiently managing the necessary clerical and mathematical operations of market value estimation, while permitting the appraiser to exercise professional skill and judgment.

In determining the market value of a subject property an appraiser generally considers three separate approaches to value; the Cost Approach, the Income Approach, and the Sales Comparison Approach. This invention is specific to the Sales Comparison Approach. The sales comparison approach to value is premised on the economic principal of substitution. As applied in the sales comparison approach, the principle of substitution holds that the value of a property tends to be set by the price that would be paid to acquire a substitute property of similar utility and desirability within a reasonable amount of time. This principle implies that the reliability of the sales comparison approach is diminished if substitute properties are not available in the market. An important component of this invention is to assist in overcoming the problem of diminished reliability by making available to the valuation professional efficient access to an increased number of substitute properties, inventoried with accurate and enriched property attributes.

It is important to note that simply applying technical and quantitative procedures does not derive a market value estimate; rather, it involves the exercise of judgment. An appraiser produces a meaningful, defensible market value estimate by considering three criteria: appropriateness, accuracy, and quantity of evidence. For a property such as an owner-occupied dwelling, the sales comparison approach is likely to be of primary relevance and thus the most appropriate. The accuracy of an appraisal is measured by the appraiser's confidence in the correctness of the data, the calculations performed in the approach, and the adjustments made to the sale price of each comparable property. The invention's initial focus on data and data quality is a direct extension toward meeting the appraiser's accuracy needs. The quantity of evidence is measured by the appraiser's confidence in capturing the dynamics of market behavior across multiple dimensions. A buyer's offer price is conditioned by a wide array of elements of comparison, some of which exist within the boundary of the parcel and many others that exist outside the boundary of the parcel. The invention's spatial integration of data is a direct extension toward supplying the appraiser with as much data as possible in compliance with standard appraisal methods.

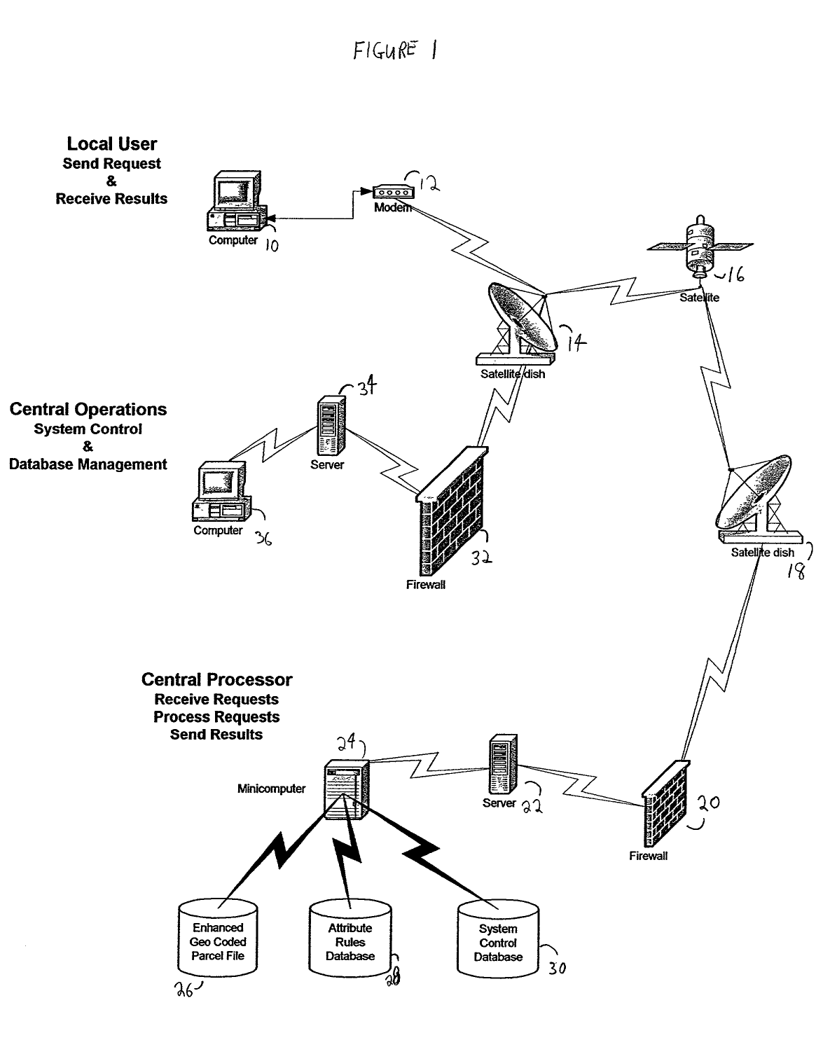

The invention is preferably performed by means of a computer, more preferably by means of local computers communicating through the Internet to central operations and central processing sites. FIG. 1 is a schematic representation of a typical preferred Internet system. At the local user level is the necessary computer hardware and software 10 and modem 12 needed to communicate via the Internet. Communication can be through land lines (not shown) or through satellite links as illustrated by satellite dishes 14 and 18 and satellite 16. At the central processor level is the computer hardware and software, comprising server 34, computer 36 and optionally firewall 32, necessary to receive requests, process the requests, and send the results. At the central processor level is the computer hardware and software, comprising server 22, computer 24 and optionally firewall 20, are the necessary systems and data management operations responsible for maintaining the databases, comprising enhanced geo coded parcel database 26, attribute rule database 28 and system control database 30, and operational functions of the valuation process.

A preferred method of the invention comprises the steps of:

A. providing a computer, wherein the computer is connected to at least one input device and at least one output device and is capable of accessing, reading and executing real estate valuation software;

B. inputing unique location data corresponding to the parcel into the computer;

C. executing the real estate valuation software to obtain at least one result based on the input data, the result being in the form of an estimated value for the parcel; and

D. communicating the value of the parcel obtained in Step C by means of the output device,

wherein the real estate valuation software comprises computer readable and executable instructions for performing at least the following functions:

(i) compiling a database of records of individual parcels comprising the subject parcel, wherein the records comprise attributes of the individual parcels;

(ii) assigning appropriate geocodes to the individual parcels;

(iii) correlating the subject parcel and the comparable properties to respective Census Tracts and Census Blocks by means of the respective geocodes;

(iv) modeling the database to determine market-driven attribute adjustment values;

(v) selecting the most similar comparable properties, wherein the comparable properties are individual parcels having attributes similar to the subject parcel; and,

(vi) calculating an estimated value of the parcel on the basis of the selected comparable properties.

The above method produces a real estate valuation apparatus comprising:

A. A computer operatively connected to at least one input device and at least one output device, and

B. real estate valuation software which executes at least the following functions:

(i) compiling a database of records of individual parcels comprising the subject parcel, wherein the records comprise attributes of the individual parcels;

(ii) assigning appropriate geocodes to the individual parcels;

(iii) correlating the subject parcel and the comparable properties to respective Census Tracts and Census Blocks by means of the respective geocodes;

(iv) modeling the database to determine market-driven attribute adjustment values;

(v) selecting the most similar comparable properties, wherein the comparable properties are individual parcels having attributes similar to the subject parcel; and,

(vi) calculating an estimated value of the parcel on the basis of the selected comparable properties,

wherein the computer has access to and can execute the software.

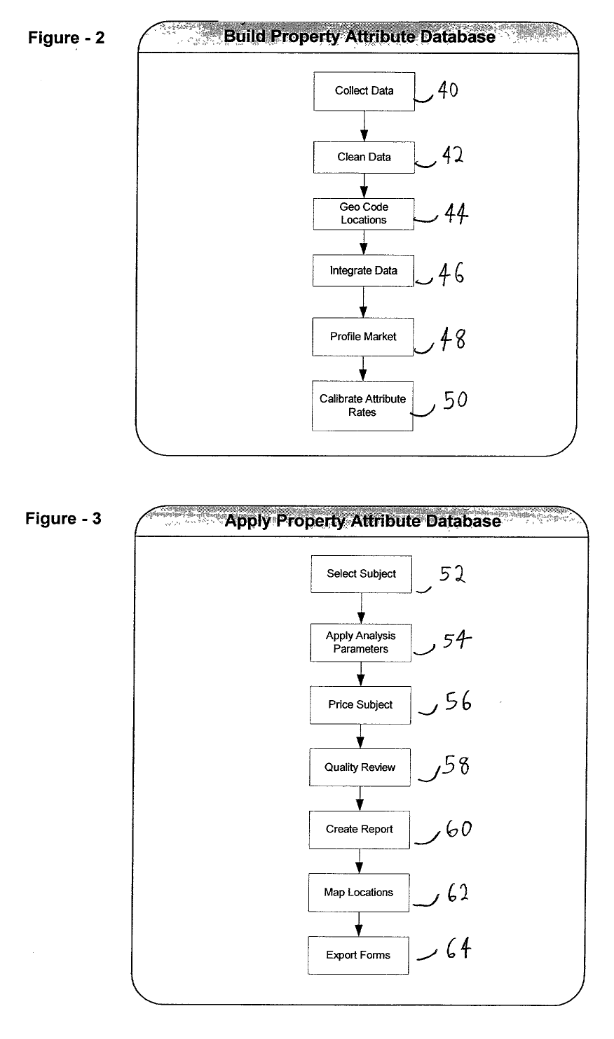

In general the process of the invention can be divided into two primary segments. The first primary segment (see FIG. 2) is the creation of a set of procedures to build the necessary property attribute databases comprising the steps of collecting data 40, cleaning the data 42, geocoding the property locations 44, integrating data to specific levels of geography 46, simulating market behavior to profile the market 48, and calibrating pricing factors 50. The second primary function (see FIG. 3) is the creation of a set of procedures to apply the rules of appraisal to the property attribute databases in order to select a subject 52, apply analysis parameters 54, estimate the value of a subject property 56, quality score 58 the results, produce final reports 60, map the locations 62 and provide for exporting 64 the results, preferably to a forms generator.

In general the components of a preferred embodiment of the valuation process are: packaging attributes; macro neighborhood assignment; modeling sale condition and scoring; subject property marketability scoring; county (municipality) level market calibration; determination of time adjustment limits; determination of adjustment rates that minimizes absolute percent difference; adjusting comparable selling prices prior to pricing subject property; identifying and selecting comparable transactions; refining adjustment rates to reflect micro neighborhood conditions; quality scoring the analysis results; and, controlling user access to program functionality. This valuation process consists of four (4) components that work together to automate most of the clerical effort required by professional appraisal practice

A buyer's offer price is conditioned by a wide array of elements of comparison, some of which exist within the boundary of the parcel and many others that exist outside the boundary of the parcel. It is therefore necessary to determine comparable similarity and therefore price with a data set that includes attributes existing within and beyond the boundary of the parcel.

A preferred embodiment of the method of the invention organizes its custom database into the following eight (8) general categories: parcel inventory; parcel inventory enrichment; spatial identification (e.g., neighborhood delineation, multiple levels of geography, etc.); neighborhood level social/economic profile; neighborhood level land cover profile; neighborhood level land use profile; linkage (location) to specific attributes; modeled sale condition

As shown in FIG. 2, a preferred embodiment of the method of this invention begins with collecting data 40 by obtaining records, preferably a copy of the public record file (such as those collected by the assessor), of real estate parcels within a defined area. Such public record files or other parcel records are readily available and can be purchased from a commercial source, or directly from the public entity, and contain the basic attributes of the parcels, such as an improvements inventory. The following discussion does not identify an all-inclusive list of attributes. For example in Jefferson County, Colorado, the public record contains an attribute referred to as “quality”. This attribute is unavailable in any other county in the Denver metro area. Preferably, before the public record information is used for valuation, it is extensively checked for errors, enriched with additional attributes, and finally modeled to create unique attributes to support the valuation process. The purpose of the database development segment is to create a data set that is accurate and rich enough to capture the dynamic interactions between buyers and sellers. The data set is defined for a geographic area and across geographic areas, allowing for value estimates of superior quality to be derived and supported.

Cleaning the data 42, by applying a data correction process, is preferred on the premise that including property records with some of the attributes estimated is better than excluding records due to missing or incorrect attribute values. By including as many property records as possible, and then permitting the user to have control to include or exclude their use, the availability of properties for use is greatly expanded. As such, the database includes a majority, preferably substantially all, of the parcel records available in the pertinent geographic area.

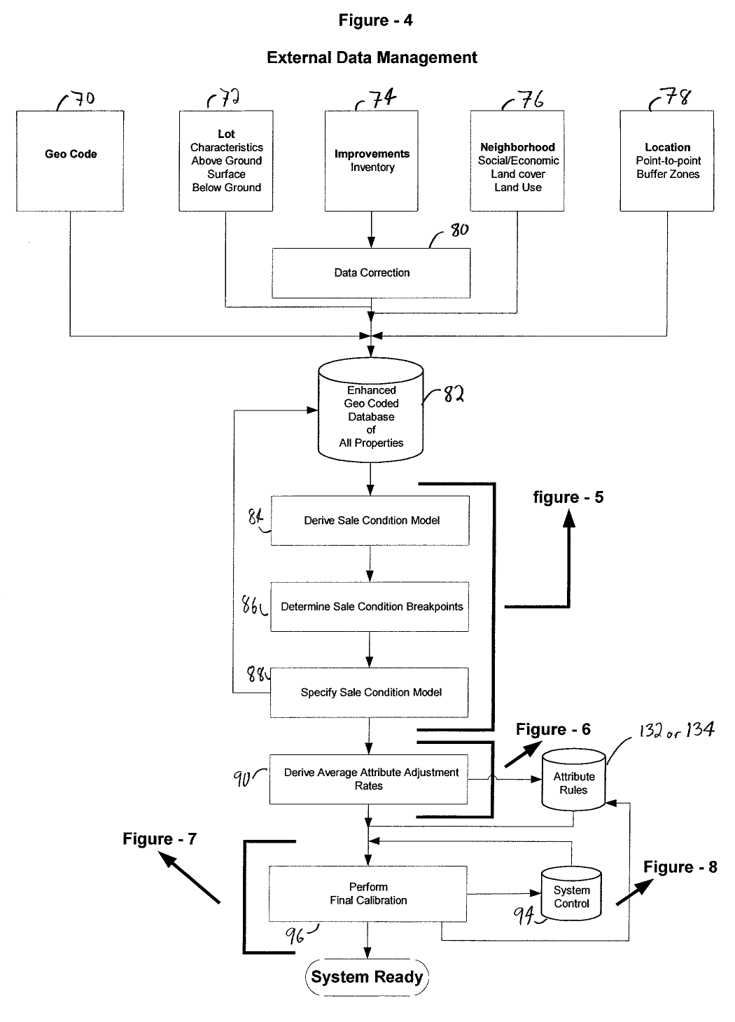

The external data management process to produce an enhanced geocoded database 82 is shown in more detail in FIG. 4. The parcel records, represented by improvements inventory 74, is obtained. During the data correction process 80, if the attribute value is missing or incorrectly stated (meaning that the indicated value is out of bounds) it is replaced with an appropriate estimated value and a record flag is set to note the estimation. Three types of attributes are analyzed and “corrected”: interval, discrete, and implied. The correction of missing attributes is described below for each of these data types.

Interval attributes includes, inter alia, lot size, living area, garage size and basement size. Interval data are reviewed and corrected in the following manner. A statistical procedure is applied to the attributes. Any suitable statistical procedure can be used. For example, the process may begin by first determining the median value for each interval attribute, at both the Census Block Group and Census Tract level, or some other reasonable level of geography and the percentage of observations with incorrect or missing data values. Each property is then examined and missing or incorrect values are replaced with the statistically estimated value from the specified level of geography in which the property is located. The determination of which value to use, could be based on the percentage of properties in the Census Block Group with missing or incorrect values. For example, if more than 33% of the properties within a Census Block Group are missing or incorrect, then the Census Tract statistically estimated values could be used.

Discrete attributes includes, inter alia, number of bedrooms, number of bathrooms, number of total rooms, number of fireplaces, number of stories and garage type. Discrete attributes are reviewed and corrected in the following manner. A statistical procedure is applied to the attributes. Any suitable statistical procedure can be used, preferably, a procedure generally referred to as “Stepwise Discriminant Analysis”.

The data used to “build” the model are all properties within a county, within the individual categories of single-family, attached, or condominiums, that do not have missing or incorrect data items. The model is then used to estimate the attribute of interest for all properties, within the category, i.e. the number of bedrooms for all single-family homes. Finally, all property records are examined, and if a missing or incorrect attribute value is detected it is replaced with an appropriate estimated value and a record flag is set to note the estimation.

Implied attributes are attributes that are not explicitly provided in the record but which can be estimated from other available data in the record. An example of an implied attribute would be “Basement Square Feet” where the square footage is empty but the “Finished Square Feet” is indicated, or “Basement Type” indicates a walkout or full basement. In these situations the “Basement Square Feet” is set equal to the first floor area. These attributes are usually very specific to the data for a particular location.

Creation of derived parcel inventory attributes recognizes that a buyer's offer price is conditioned by perceptual relationships as well as absolute relationships. For example, an absolute relationship is the square feet size of the living area, and competing properties can be compared in absolute terms. However, an equally important attribute is the average room size. This derived attribute is intended to capture the market's interplay between living area and number of rooms. An equally important relationship is lot coverage ratio. While lot size and living area can be evaluated separately, the perceptual condition of a large building on a small lot has a unique market response. Using these derived attributes from the parcel inventory makes the inventive method more sensitive to market behavior and allows the process to identify and select comparables that are more reflective of subtle market conditions.

Once the basic attributes have been inventoried and corrected, various derived ratios can be created, such as, inter alia, the following: lot-coverage ratio (living area divided by lot size);bed-to-bath ratio−(bedrooms divided by bathrooms); bed-to-rooms ratio (bedrooms divided by total rooms); average room size (living area divided by total rooms); basement square feet (equal to first floor area); basement percent (basement square feet divided by first floor area); basement finished percent−(basement finished square feet divided by basement square feet).

The inventive method also determines the spatial location attributes of each parcel. For each parcel, the address information (street number, name, type, suffix and direction) or locational identifier is entered into a file and processed into the appropriate geocode 70, for example a commercial geocoding product. This geocoding 70 converts the locational information into an estimate of latitude/longitude coordinate for locating the parcel on the earth's surface. Once the parcel geocoded location is known, the parcel can be referenced to any other geographic or political identifier. For example, in a preferred embodiment, the Census Tract and Census Block Group identifier (FIPS) code is attached to each property. In this way each parcel can be referenced by the Census Tract or Census Block Group in which it is located. Likewise, the parcel can be referenced to the local school district and attributes of the school district can be attached to the parcel record. Other such references are readily apparent to one skilled in the art and are considered as part of this invention.

It is well understood that a buyer's purchase decision is conditioned not only by the composition of the attributes of the parcel but also by the neighborhood 76 surrounding the parcel. Household income, family size and age, along with employment type all impact on the decision to purchase. The inventive method uniquely addresses this issue by identifying alternative neighborhood boundaries, such as Census Tract and Census Block Group, and then defines a social/economic profile, a land cover profile, and a land use profile intended to capture the market's response to neighborhood composition 76. Attributes packaged in the database preferably include demographic characteristics resolved to the smallest spatial level (such as the Census Block Group level) or traffic analysis zone (TAZ).

By attaching social/economic profile attributes to each property in the database, the inventive method can incorporate neighborhood social and economic characteristics 76 in its simulation of the purchase decision. For example, homebuyers with younger children will tend to purchase a home in neighborhoods with younger children. The following is a partial list of attributes that may be assigned to each property in the database based on the Block Group Assignment: population less than 16 years old; population greater than 18 years old; median household income; average household income; median age; number of persons unemployed; percent white collar occupation; percent blue collar occupation; persons employed in the armed forces; household density; and, percent ownership.

By attaching land cover profile attributes to each property in the database, the system can incorporate neighborhood natural characteristics in its simulation of the purchase decision. For example, homebuyers will tend to pay more for a parcel located in an area extensively wooded or an area with water present. To provide for maximum sensitivity to small area changes; the land cover profile is established at the smallest resolution level possible. The following is a partial list of attributes for each property in the database based on Block Group Assignment: percent surface water coverage and percent tree cover.

By attaching land use profile attributes to each property in the database, the system can incorporate neighborhood land use characteristics in its simulation of the purchase decision. For example, homebuyers will tend to pay more for a parcel located in an area extensively filled with owner occupied properties. To provide for maximum sensitivity to small area changes; the land use profile is established at the smallest resolution level possible. The following is a partial list of attributes for each property in the database based on Block Group Assignment: single-family residential parcel density; attached residential parcel density; apartment density; retail density; office density; manufacturing density, and, agriculture density.

The system also determines linkage (location) attributes 78. Homebuyers partially determine their offer price based on minimizing the cost of friction between the home and outlying service needs. Spatial relations to shopping, school, church, friends, and recreation all impact on the offer price. To assist in recognizing the disutilities of overcoming distance in moving people or goods from one place to another, the system adds to its property inventory distance measures between each residential property location and specific points of interest. To simulate this market dynamic, the system preferably calculates the point-to-point distance to certain important locations.

To determine the shortest distance from each residential property location to each point of interest (e.g., schools and grocery stores); the locations of the points of interest must first be identified, such as by street address or other locational identifier. The locations are then geocoded using the same procedure outlined above in the spatial locator section. Following the geocoding of the points of interest, the determination of distance between each residential property location and the points of interest can be determined using standard geographical calculations. For the purpose of this task, the standard formula for calculating distance, where Latitude and Longitude are known, was used. This is commonly referred to as Great Circle Distance, and can be calculated using Degrees or Radians. This formula was used to compute and select the shortest distance from each residential property location to each point of interest.

The system adds the point-to-point distance measures to the property records, such as, inter alia, the following: nearest public elementary school; nearest public middle school; nearest public high school; and, nearest grocery store.

Some attributes, due in part to their size, cannot easily be managed with a point-to-point distance estimator. For example, a public park generally covers an extended amount of area. To compute the shortest distance from a subject parcel to the park would require tracing the park boundary and computing distance from a number of points until the shortest distance can be found. An alternative, while not as accurate as the point-to-point method, is to construct buffer zones around the park and then identify which zone the individual parcel is located.

A buffer zone is a type of proximity analysis where areas or zones of a given distance are generated around selected objects. Buffers are user-defined or can be generated for a set of objects based on those objects' attribute values. The resulting buffer zones form region objects representing the area that is within the specified buffer distance from the object.

To determine the buffer zone that each parcel exists in it is first necessary to create the buffer zones about the attribute of interest. The buffer procedure would first determine several buffer zones; for example ¼ mile, ½ mile, ¾ mile, 1 mile, greater than a mile. Then utilizing a buffer zone calculator available in most electronic Geographic Information Systems (GIS) the boundaries of the zones can be determined and mapped. Following the determination of the zone boundaries it is a standard mapping procedure to perform a point append function to determine which zone any particular point is located in. Preferably, the system adds the following distance measures to the property records: transportation networks; streets, bus routes, interchange; utility networks; railroads, power lines, gas lines; flood zone; and, lakes/streams.

While the extent and quality of the improvements made to a parcel have a major impact on the parcels value, the physical condition of the lot 72 can also have a significant impact on value. A parcel's condition, such as slope steepness (percent slope), the direction the slope is facing (slope aspect), and the parcel's elevation (relative to surrounding parcels) contribute directly to a parcel's value. To capture these types of attributes the system preferably applies Geographic Information Systems (GIS) technology to identify and map various conditions, which can then be attached to individual parcels. To assist in this process the system preferably divides this process into the following categories: conditions above the surface (such as view, noise, odor); conditions at the surface (such as slope aspect, percent slope, relative elevation); and, conditions below the surface (such as soil classification, depth-to-rock, depth-to-water).

The need to select additional sales generally occurs when a user cannot identify a sufficient number of acceptable sales within the Census Tract or radial distance (geography) of the property being valued and therefore must expend the search into locations that are similar to that of the subject property. To evaluate the desirability of one location relative to other locations, sales of physically similar properties located in different locations must be analyzed. The purpose of the macro neighborhood assignment is to provide an opportunity to the user to select comparable sales from a geography that is larger than the Census Tract. The operational design is to combine Census Tracts into groups that share important attributes, thus enabling comparable sales to be selected from similar neighborhoods.

To accomplish the macro neighborhood assignment process a suitable statistical procedure, such as conical analysis, factor analysis or cluster analysis, is used. Preferably, this grouping is accomplished through the use of the statistical procedure referred to as Cluster Analysis.

In general, the purpose of Cluster Analysis is to join together objects into successively larger clusters, using some measure of similarity or distance. At the beginning of the analysis, individual Census Tracts that share important attribute scores are linked together into small groups. The small groups are then linked together into larger groups and the larger groups are linked together into still larger groups. At the conclusion of the analysis, all Census Tracts are joined together into a single group representing the county. Through evaluation of the grouping process, individual Census Tracts can be assigned into representative groups that share important attribute scores. A consistent method is thereby established that permits selection of comparables from locations outside the Census Tract of the subject but which share important attribute scores such as size, age, condition, neighborhood profile, etc.

Fundamental to the application of the sales comparison approach is the notion that prior to use, a comparable's selling price needs to be reviewed for acceptability. This is generally referred to as “Conditions of Sale” and is reflective of the motivations of the buyer and seller. If the sales used in the sales comparison approach reflect unusual situations, an appropriate adjustment must be made for motivation or conditions of sale, or the comparable must be rejected as a market indicator.

An additional concern is that at the time of purchase, some transactions will be out of sync, relative to the Sale Price and attribute inventory. If the sale price is reflective of conditions not present in the property inventory, then the inventory cannot accurately reflect market behavior. The actual number of out of sync transactions is a function of market dynamics (sale frequency) and property inventory updating. Many local assessor departments only update inventories of sold properties on an annual basis, and in some instances even less frequently.

Through the application of statistical inference tools, the inventive method establishes a set of procedures that use the custom database to review the supportability of all comparable sale prices. Following a comparable's sale price review, the method assigns an indicator code, known herein as “sale condition”, that suggests to the user the relationship between a comparables selling price and its attribute inventory. While the method cannot determine the specifics of why a comparable's selling price may not fit its expected pattern, the indicator code is a cautionary note to the user relative to the quality of the selling price being an acceptable market indicator. This analysis is divided into a two-step process. The first step is to review and score each comparable relative to the supportability of the comparable's selling price. The second step is to determine an appropriate adjustment amount for differing condition scores.

The scoring of a comparable's selling price is based on the premise that through the use of the corrected and enriched database, a generalized pricing model can be developed that would estimate a comparable's selling price with reasonable accuracy. When the difference between the estimate and actual prices are excessive, the condition should be noted and the user informed of the condition. For example, if the inventory is incomplete, the buyer's offer price may be partly based on the newly finished basement, while the estimate was derived with data indicating an unfinished basement. A further example would be if subtle market forces were at work shifting the values of all properties in the neighborhood.

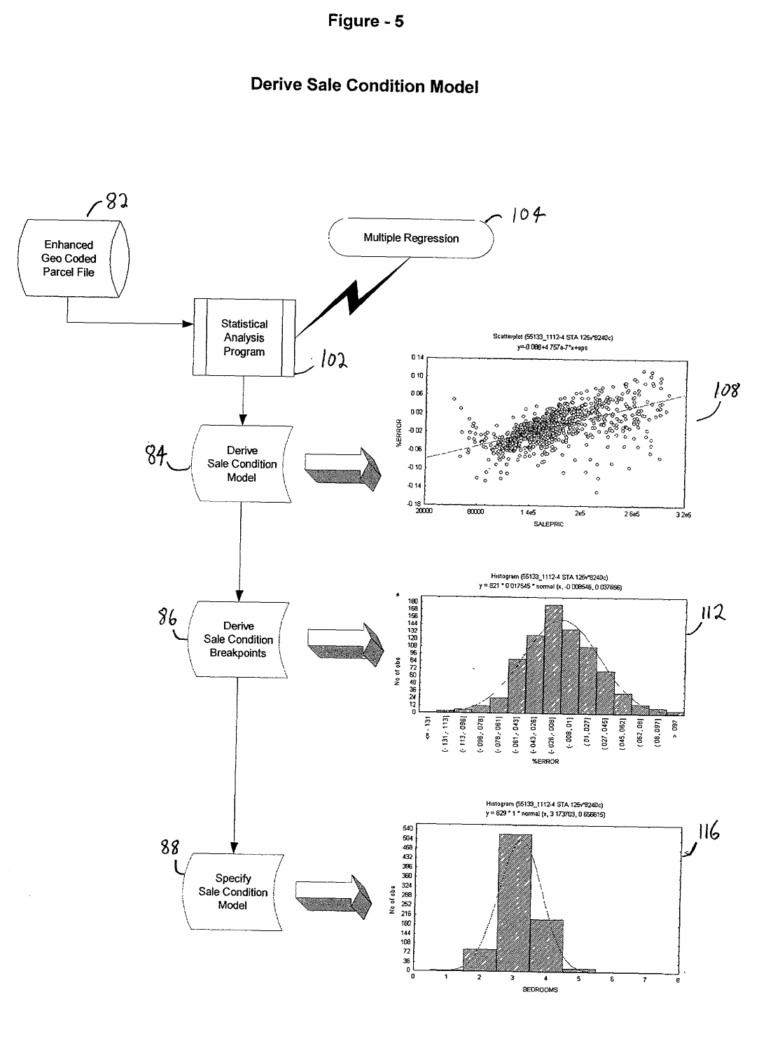

The development of a sale condition model is shown in FIG. 4 and, in more detail, in FIG. 5. The enhanced geocoded parcel file 82 is analyzed with a statistical analysis program 102. Preferably, the statistical analysis 102 used to estimate a comparable's selling price is multiple regression 104, more preferably, forward stepwise regression. In forward stepwise regression, independent variables are individually added or deleted from the model at each step of the regression until the “best” regression model is obtained.

In one preferred embodiment of the invention, the sale condition model 54 is determined as follows. First, records of recent sales, e.g., sales within the past 18 months within the county, are selected. Each attribute in the record is reviewed, the outliers are eliminated and the results are summarized. Next, the “sale age” (i.e., date of sale less date of analysis) and the “sale price to assessed value ratio” (i.e., sale price divided by assessed value) are derived from the summarized records. Then a forward stepwise regression is performed in which the independent variable is the selling price and the dependent variables comprise all attributes including assessed value. Next, residual analysis is performed to determine both the standard residual value and the Mahalanobis distance. Unusual data records are identified and deleted. If necessary, another forward stepwise regression is performed. All data records with a standard residual outside a designated range, or having a large Mahalanobis distance are identified and deleted. A final forward stepwise regression is performed in which the variables are the same as the first forward stepwise regression. The resulting regression model is applied to all recent sales and the percent difference is scored.

The sale condition score is determined from the actual sales price and is modeled as follows. First, the residual errors (i.e., actual sales price less predicted sale price) are derived and converted into percent error 108 (i.e., divide residual error by actual sale price). Second, the average and the standard deviation of the percent error is calculated. These results may optionally be filtered. Such filtering is preferably at ±10% error percent. Third, the sale condition break points 86 are determined as shown in histogram 112 and used to specify a sale condition model 88. Such a sale condition model 88 is shown as histogram 116. A typical set of breakpoints for a 5 point scale is:

sale condition 1=percent error less than sale condition 2;

sale condition 2=from sale condition 3 to sale condition 3 minus 1 standard deviation;

sale condition 3 (typical property)=((mean percent error ±standard deviation * factor A));

sale condition 4=from sale condition 3 to sale condition 3 plus 1 standard deviation;

sale condition 5=percent error greater than sale condition 4

The percent error, when filtered at ±10%, generally has a very well defined normal distribution. With a normal distribution, ±1 standard deviation will cover 68% of all observations. The factor A is used to select a portion of the standard deviation to be used to indicate “typical” pricing. For example, a factor A equal to 0.73529, multiplied by the standard deviation of the percent error, will identify the 50% range.

The subject property marketability is frequently included in the valuation analysis in the use of such terms as “curb appeal”, “unusual condition”, “superior to”, or “inferior to”; it is a judgment made by the valuation professional and is reflective of the subject property's perceived competitive position, relative to characteristics of competitive properties. By scoring the comparable property's selling prices, it is possible to provide similar scoring to the subject.

When a subject property is initially processed, its sale condition score is preferably set equal to the average of the sale condition scores (rounded to the nearest whole score) of the comparables that will be used to price the subject property. The subject is scored as being typical for its neighborhood, which is represented by the comparables being used to estimate its price. However, if the subject property is perceived by the system user as being inferior or superior to the comparable properties, it can be scored as such and the process will adjust for the difference. This adjustment permits refining the comparable selection process toward comparables that may share similar marketability conditions as the subject.

The Special Condition attribute is used for situations where the user determines that a dollar adjustment, either negative or positive, is warranted. Entering a dollar adjustment in the subject's Special Condition field results in the comparables being adjusted, either up or down, by the amount entered. Using this attribute allows for the relatively easy incorporation of such items as hot tubs, landscaping, recent remodeling, etc.

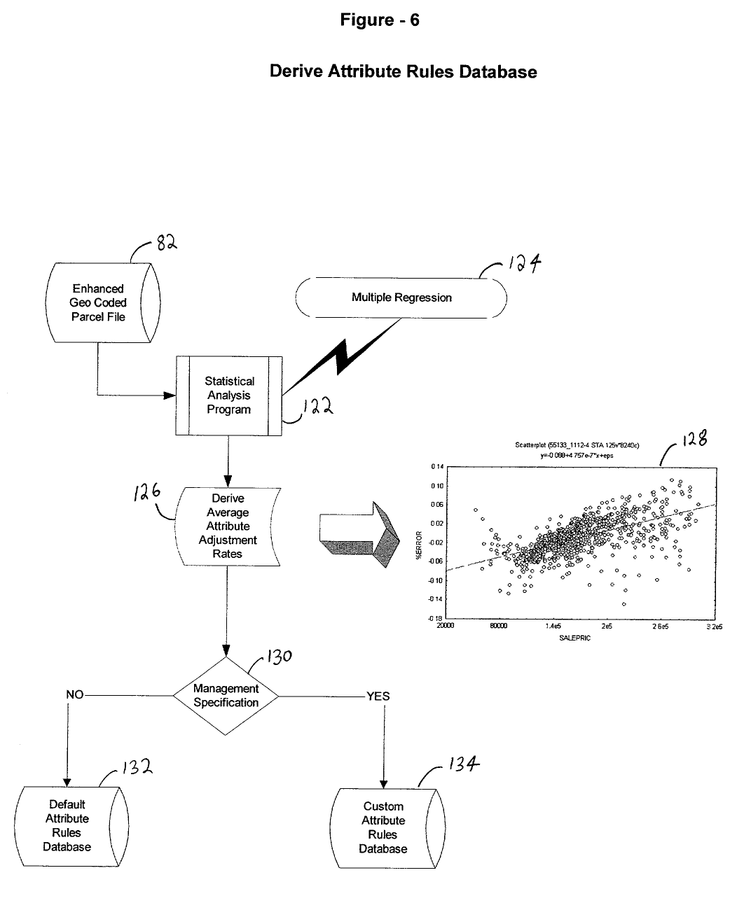

Attribute measures of importance need to be derived from the market segment expected to bid on the subject property. The attribute measures need to be sensitive to changing market conditions and reflective of local micro neighborhood conditions. Prior to their being used to price a subject property, attribute adjustment rates 90 (measures of importance) pass through a series of statistical analysis programs 122, such as multiple regression 124, designed to reflect micro market conditions as shown in FIG. 6. The first series of statistical analysis programs 122 are performed on a regular schedule, depending on sales activity and changing market conditions on a county-by-county basis to derive average attribute adjustment rates 126, as illustrated by scatterplot 128.

Preferably, the method provides for management specification 130 to select the default 132 (the derived attribute adjustment rates) or a custom attribute rates 134 of user selected adjustment rates.

The purpose of the county level market calibration function is to provide to the pricing process average attribute adjustment rates 90 that are reflective of recent market trends. As-of the date of analysis, prior transactions occurring within a designated timeframe, e.g., from the past 18 months are analyzed. By going back far enough, e.g., 18 months in time or more, a sample size large enough to support advanced statistical analysis is established.

As shown in FIG. 6, the preferred attribute derivation process is performed in the following sequence of steps: perform statistical analysis, preferably multiple regression, more preferably forward stepwise multiple regression, most preferably forward stepwise ridge regression. Ridge regression analysis is used when the independent variables are highly intercorrelated, and stable estimates for the regression coefficients cannot be obtained via ordinary least squares methods.

Determining the average measure of importance of each important attribute by forward stepwise ridge regression provides more intuitively reasonable results. Through the use of a forward stepwise ridge regression, the attribute adjustment rates can be organized into acceptable forms. For example, it is quite common for a normal stepwise regression to identify a positive adjustment rate for bathrooms and a negative adjustment rate for bedrooms. While this can be explained in statistical terms, most professional users find this relationship unacceptable. Therefore, the ridge regression procedure, while reducing the overall quality of the model, permits structuring the adjustment rate such that both bedrooms and bathrooms have positive adjustment rates, thus making the results more acceptable to the user.

The inventive method derives the average measure of attribute importance 126 by performing the following steps: select recent sales (e.g., sales within the past 18 months within county); review each attribute and eliminate outliers; summarize results; perform forward stepwise ridge regression wherein the dependent variable is selling price and the independent variables are all attributes excluding assessed value, sale price to assessed value ratio, and macro neighborhood; solve for lambda resulting in positive bedroom and bathroom beta coefficients; perform residual analysis such as standard residual value and mahalanobis distance; identify and delete any unusual data records; if necessary, perform forward stepwise ridge regression.

The resulting regression model is determined to be the most acceptable representation of the market's average pricing and is the beginning point for the pricing of a subject property.

By deriving its initial set of average adjustments from a large number of sales (generally thousands), supported with custom inventories, over an extended time frame (e.g., 18 months), several advantages can be realized, when compared with alternative AVMs. The results of the statistical analysis are more true estimates of what the market is actually applying in deriving estimates of value. These more realistic average adjustment rates become more acceptable by users.

Secondly, the determination of value, by the valuation process, does not become dependent upon a minimum set of comparables. Several AVMs require a minimum number of transactions be available to the analysis. In some instances, the minimum is 10, and in others, the minimum is as many as 25. If the minimum number of transactions is not available, the analysis cannot be performed and in some markets where there is not a great deal of market activity, these AVMs become unavailable for use.

This inventive process, of externally deriving the adjustments rates, results in it being able to value a subject with as few as three comparable sales and still apply market derived adjustment rates.

During the valuation of an individual subject property, the internally derived adjustment for time (changing market conditions) can become greatly skewed, usually due to having only a limited number of data points with vastly different selling prices to evaluate. A minimum and maximum range for the time adjustment is determined. The calibration process computes a minimum and maximum acceptable time adjustment range. This range then becomes the controlling factor for time adjustment during the valuation of a specific subject property.

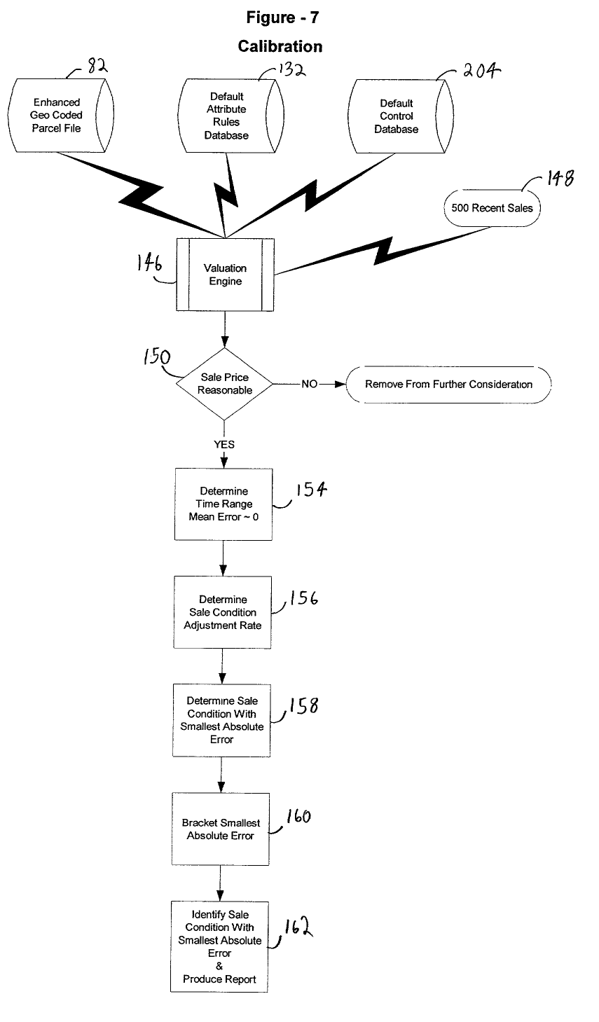

The objective is to determine a time adjustment range, as shown in FIG. 7, that will result in an unbiased average error of approximately zero (0), from a sample of recent sales. For this purpose a stratified sample of recent sales 148 (generally several hundred) is identified for analysis and each sample is processed multiple times 146.

During the first processing, the adjustment range for time is set at a minimum of 1.0 and a maximum of 1.0. This indicates to the valuation process that no adjustment for time is to be made and the adjustment for sale condition is set at zero (0). As each of the sample properties is priced, its estimated price is compared to its indicated price, and the percent difference is computed and the indicated time adjustment (if it had been permitted) is noted. At the completion of the pricing process, for all properties in the sample, the average, median, standard deviation, and skew of the individual errors and the indicated time adjustments are computed.

The low range for the time adjustment is set equal to the average adjustment for time less one (1) standard deviation. The high range for the time adjustment is set equal to the average adjustment for time plus one (1) standard deviation. The low and high range values are then further adjusted depending on the direction of the skew factor. If skew is less than zero (0), then the low and high values are adjusted positively by adding the result of the skew amount, multiplied by a skew factor. If the skew factor is positive, then subtracting the result of the skew amount, multiplied by a skew factor, lowers the low and high range values. The entire set of sample properties is then evaluated a second time, permitting the indicated time adjustment range.

At the completion of the second processing, the average error and average time adjustments are compared and adjustments computed. Depending on whether the skew is negative or positive, and if the average error computed at the end of the second process is closer to the unbiased value (0), the low and high time ranges are adjusted by adding or subtracting ½ of the standard deviation. Then, depending on whether the skew is negative or positive, the range is adjusted by adjusted the skew amount.

The entire set of sample properties is then evaluated a third time, permitting the modified time adjustment range. At the completion of the third processing, the time range resulting in the average selling price error that is closest to zero (0) is identified and used for all further processing.

The sale condition attribute 156 is so highly correlated with the adjustment for time and the average attribute adjustment rates, computed with the ridge regression, that to included it in the statistical analysis would cause the other attributes' adjustments to become skewed and/or incorrectly stated. The goal of next step is to determine the amount of the adjustment rate for sale condition that minimizes the average absolute percent difference between the estimated selling price and the reported selling price of a random sample of recent sales.

Each sale from the sample used to derive the time adjustment range is processed, and the absolute percentage difference between the sample's indicated selling price and its estimated price is noted. After each sale has been processed, the average, median, and standard deviation of the absolute percent differences are computed. This process begins with the adjustment rate for sale condition set equal to zero (0). At the completion of the first processing, the adjustment rate for sale condition is incremented by a fixed amount. The process is repeated until the adjustment rate approaches a predetermined maximum amount (say $50,000). The resulting combinations of average absolute percent difference 158 and adjustment amounts are then examined, and the adjustment rate resulting in the smallest average absolute percent difference is identified for further processing.

The next series of processing 160 begins by identifying a beginning value. The beginning value is determined from the mid point between the adjustment amount, resulting in the smallest average absolute error, and the prior smaller adjustment amount. Beginning with this mid point amount, the adjustment rate for sale condition is incremented by a fixed amount, and the process is repeated until the adjustment rate exceeds the ending point. The ending point 162 is determined as the mid point between the adjustment amount, resulting in the smallest average error, and the next larger adjustment amount.

At the completion of the county (municipality) level calibration, the analysis has resulted in establishing market based average attribute rates, the identification of the minimum and maximum time adjustment range resulting in an unbiased error range, and an adjustment rate for sale condition that minimizes the absolute percentage error. The resulting combinations of average absolute percent difference and adjustment amounts are then examined, and the adjustment rate resulting in the smallest average absolute percent difference 162 is identified. This information is then provided to the valuation model for use in pricing subject properties.

The purpose of the valuation model is to access the custom database, complete with updated and scored comparable sales, apply the rules of appraisal, infer a value to the subject property, and review the resulting value estimate for quality. This process has three functional areas: external system controls, run time controls, and automatic rule application. The external and run time controls are unique to the inventive method and are meant to address the Uniform Standards of Professional Appraisal Practice (USPAP) Advisory Opinion (AO-18) regarding appraiser use of AVMs.

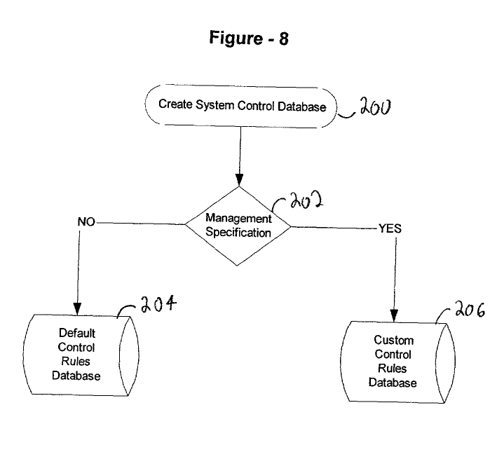

As shown in FIG. 8, the external controls are generally activated with default settings 204 established by the inventive method to produce the smallest average absolute error in the value estimate. However, a user has complete freedom to alter many of these parameter sets by means of the management specification 202 to create a custom control rules 206. For a typical institutional client, the inventive method does not permit user access to the quality scoring components of the external controls. To guard against fraud, the quality scoring, which represents a specialized ability to institute user policy control, is managed by the inventive method for an institutional user, but is not accessible by the user. Typical external controls include, inter alia, policy control; attribute adjustment rate control; attribute display control; and, primary attribute filter control.

The Run Time Control defaults are set by the inventive method, but frequently are modified by the user. It is not uncommon for the subject inventory to be incorrect or to apply specific attribute filters. The user commonly modifies these controls. Typical run time controls, and associated defaults, include, inter alia, as-of date for analysis (default—day of analysis); identify date range for comparable search (default—1 year back in time); identify geography for comparable search (default—census tract); update subject inventory (default—as-is from database); apply attribute filtering (default—no filtering); add specialized user identification (i.e. name of borrower, loan code)(default—no data); test value estimate (default—no estimate).

The valuation process has been designed to follow the rules of appraisal, as defined by the Appraisal Institute, as closely as it can. Such rules can be found in The Appraisal Of Real Estate, Tenth Edition, Chapter 17, The Sales Comparison Approach, p. 366-407, Appraisal Institute, 875 North Michigan Avenue, Chicago, Ill. 60611-1980, 1992.

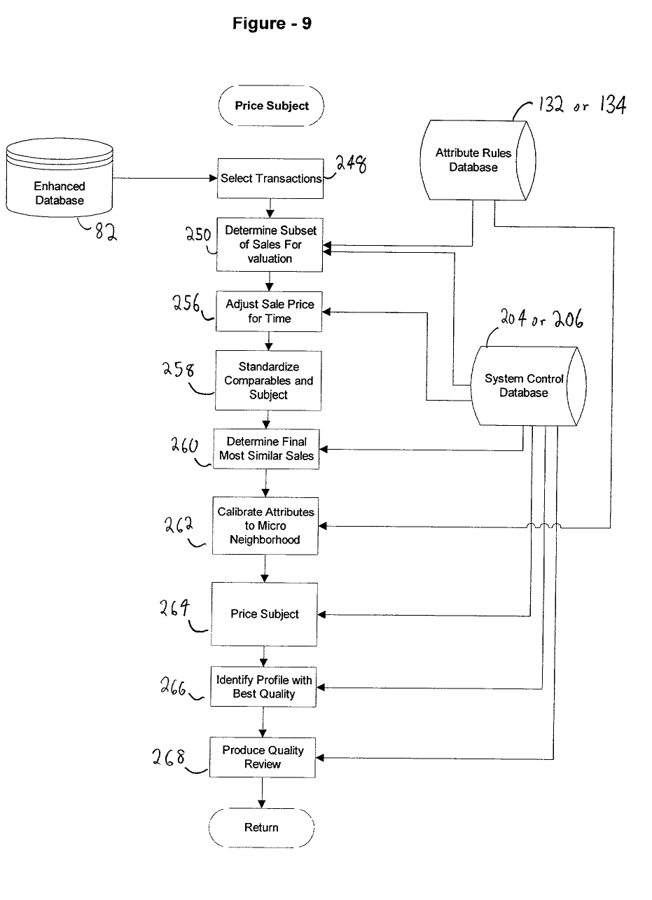

The rules applied by a preferred embodiment of the invention shown in FIG. 9 include, inter alia, the following: select transactions 248 from database 82; identify similar comparable sales 250 (apply filter rules from policy controls 204 or 206); determine time adjustment (apply time range control from policy controls 204 or 206 (control for extreme values)); determine time adjusted sale prices 256 for comparable sales (identify final set of comparable sales (apply primary attribute filter controls (market determined important attributes from county calibration 132))); compute time adjusted sale price for subject 256 (comparable based but without measures of importance); scale and standardize time adjusted selling prices 258 (apply outlier limits from policy controls); scale and standardize similarity score; balance and weight selling price and similarity score (apply weights from policy controls); identify final most similar sales 260; compute micro neighborhood attribute adjustment factor; adjust macro attribute adjustment rates to micro neighborhood 262; price subject property 264 (adjust for attribute difference between subject and comparable); identify final number of comparable sales (weight comparable adjusted selling price)(round weighted adjusted selling price) 266; compute quality scores 268: and, produce reports.

Comparable sales that occurred under different market conditions than those applicable to the subject on the effective date of the value estimate require adjustment for any differences that affect their values. A common adjustment for market conditions is made for differences occurring since the date of sale. Following the identification of a subset of sales, which the method refers to as “Generally Similar Sales”, the default option in the valuation process is to compute an adjustment for changing market conditions directly from the sales being evaluated. This allows the adjustment for the passage of time to be reflective of the sub market represented in the neighborhood from which the comparables were selected. The procedure used is simple linear regression of sale price (or some derivative such as sale price/sq. ft.) and sale age.

However, within the External System Controls it is possible to indicate that the adjustment for changing market conditions (time) is to be turned off or a specified rate is to be used at all times. This capability is very important in those situations where the market is changing direction. The Sales Comparison Approach to value uses prior sales (things that happened yesterday) to forecast a future transaction amount (things that might happen tomorrow) from a current position in time (things that are happening today). If an economic event has occurred that will significantly impact buyer behavior it is necessary to anticipate the markets behavior response and shift market conditions accordingly. The ability to specify an adjustment rate for time does exactly this.

Adjustment rates in the default file are maintained and updated. The rates are structured to provide the minimum average absolute error on a county-wide basis. Situations exist where, due to localized market trends, an alternative set of adjustment rates might perform better. Providing this option gives the user the ability to adjust to local market conditions. However, it also becomes the user's responsibility to establish market support for the customized set of adjustment rates.

For the limited number of competing automated valuation systems, that indicate a property's price with comparables, there exists a wide range of methods used to identify comparables, including minimum net adjustment, least absolute dollar difference, and even a Euclidian distance method. A problem with all of these methods is that the ranking and selection of comparables is biased toward minimum dollar adjustment rather than attribute similarity. To overcome the problem caused by dollar adjustments being used as comparable selection criteria, the inventive method has established a two-step process for the identification and selection of comparable transactions. The first step is the identification of similar comparables based on attribute similarity. This part of the process first standardizes the attribute scores of all the comparables and the subject property. This results in the attributes of the subject and comparable properties being measured on the same constant scale. This constant scale is then used to indicate the attribute-by-attribute difference between the subject and each comparable. These measures of difference are then ranked using Euclidian distance and the smallest distance measures are identified as the “Set of Most Similar Sales”.

The second step is to determine the dollar difference between the subject property and each of the final most similar sales by subtracting the attribute of the comparable from the attribute of the subject and multiplying the difference by the micro neighborhood's attribute adjustment rate. These measures of difference are than ranked using Euclidian distance, and the smallest distance measures are identified as the “Final Most Similar Sales”.

Following the rule that the relationship between the subject and a comparable should be expressed from the viewpoint of the market. The average attribute adjustment rates computed during the county calibration process (including the minimum and maximum range for time and the sale condition attribute) are used to price each of the final most similar comparables with the remainder of the comparables in the selected set. The purpose for doing this is two-fold. First is the notion that prior to applying a pricing equation to a subject with an unknown value, it is prudent to apply the equation to the comparables to determine how well the comparables' sale prices can be estimated. Secondly, to the extent that a comparable's time adjusted sale price cannot be estimated, it is determined that the county level average attribute adjustment rates need to be adjusted to the micro market of the subject. The difference between the time adjusted sale price and the estimated sale price of each comparable is then weighted with a sum-of-digits algorithm and applied as a micro neighborhood adjustment to the average attribute adjustment rates. At the completion of this step, the subject property is then valued with the refined adjustment rates. The determination of similarity is shifted to the traditional base of difference measured by units of importance, e.g. in dollars. Typically, known AVMs present a price estimate to the user, and as always, the user is left to decide if the price estimate provided is acceptable. Frequently the price estimate is presented with support derived in statistical terms such as confidence intervals, expected ranges, or percentage error. It is up to the user to determine if the price estimate is acceptable in terms of the business decision that needs to be made, and there is no information provided in that context.

In the inventive process, guidance is provided to the user at two specific levels of detail. In the first instance, every attribute of the subject property is compared to the distribution of the attribute in the selected comparable set. If any attribute of the subject is either too much below or above expected norms, this condition is reported to the user in the form of an “Unusual Subject Property Characteristics” Report. This information can assist the user in determining if modifications to Run Time parameters are necessary or if the subject is so different from the available comparables that any further application of the automated process is unreasonable.

The second level of user guidance occurs at the end of the pricing process. With the subject property's value estimate tied to direct market evidence, through the selection and adjustment of a set of final comparable transactions, the valuation model can review the resulting estimate of value and provide guidance as to its overall acceptability. The determination of overall acceptability is based on general appraisal rules and guidelines. This review in the inventive process is referred to as “Quality Scoring” and is displayed in a specific report. By reviewing the Quality Scoring Report a user can quickly judge the acceptability of the price estimate.

The quality scores are comprised of the following elements. The first element is the price range. For example, this score compares the valuation range from available models and might indicate if the range is large (scores 1-3), moderate (scores 4-6), small (scores 7-8), or very tight (scores 9-10). It is commonly accepted that the smaller the range, the better.

The second element is the number of sales. This score reflects the number of sales available to the model. More available sales provide a greater opportunity to identify “similar” comparable sales.

A third element is the location of value estimate. This score compares the subject property value estimate to the sale prices identified from the search parameters. The more sales with prices similar to the subject, the higher the score.

A fourth element is the quality of sales. This score compares the final comparable sales used to price the subject with the attributes of the subject property. Comparable sets determined to be very similar to the subject will be scored high (scores 7-10), somewhat similar to the subject (scores 4-6), or not very similar to the subject (scores 1-3).

A fifth element is the distance to comparables. This score reflects the distance between the comparables and the subject property. The closer the comparables are to the subject, the higher the score.

A sixth element is the subject superior/inferior score. This score reflects the practice of bracketing the subject relative to the comparables. A comparable with a positive net adjustment is inferior to the subject meaning its selling price was increased to make it appear like the subject. A comparable with a negative net adjustment is superior to the subject, meaning its selling price was reduced to make it appear like the subject. The more that the net adjustment amounts indicate a balance between negative and positive values, the higher the score.

A seventh element is the final number of comparables. This score reflects the number of “generally similar” comparables that were available to price the subject. If the number of final comparables is equal to the most similar parameter (default=10) times the multiplier factor (default =1.5) equaling 15, the highest score is given. If the number of final comparables is between the factor sum (15) and the most similar parameter (10), a moderate score is given. If the number of final comparables is less than the most similar parameter (10), the program will use all available comparables, and a low score will be given. Finally, if the number of final comparables is less than ½ of the most similar parameter, the program will use all available comparables, and the lowest score will be given.

An eighth element is the overall quality score. This score is a composite of the preceding quality scores. This score reflects an overall judgment of the supportability of the comparables used to price the subject property.

The default quality scoring is provided by the inventive method on a regional basis (e.g. county-by-county basis). The need for regional level quality scoring is based on the fact that each area (county or municipality) has its own property attribute inventory, which is maintained at different levels of timeliness and accuracy. To the extent that data quality varies area-to-area, the ability of the data to support price estimates also varies. The problem is further compounded by the fact that the price at which the property is offered and purchased may not have been its market value.

The initial analysis performed by the invention seeks the value estimate that results in the optimal application of appraisal rules. However, it is quite common for the final estimate of value to be different from what the valuation professional needs. In many instances a simple reselection, from the list of final most similar sales, can provide the answer needed. By selecting the revise comparable selection option the user can direct the program to use an alternative set of comparables and/or apply a different set of comparable weights. As a guide to the reselection of alternative comparable sales the invention provides a similarity index that provides a general indication of how similar each comparable is to the subject.

While it is common for an automated appraisal tool to allow a user to select comparables for pricing a subject property, no tool provides the user with an estimate of the comparables adjusted selling price or an indication of its general similarity to the subject.

The Similarity Index is provided as a guide when revising the comparables selected to price the subject. This index reflects the relative similarity between the subject and the comparable sales selected to price the subject. The index ranges from 1 to 10, with 1 being very different from the subject and 10 being very similar to the subject. In its initial comparable selection, the valuation process identifies three (3) comparables, in order from 1 to 3, which are most similar to the subject. Comparing the Selection Index for Comparable 3 to the Similarity Indexes of the unselected comparables allows users to gage the relative difference between an unselected comparable and the selected comparables. If the relative difference is minor, then the substitution and use of an alternative comparable will have a minor impact on the quality of the price estimate. However, if the relative difference is significant, then the substitution and use of an alternative comparable will have a significant impact on the quality of the price estimate.

The similarity index is used to convert actual adjustments to interval scores. During the phase of the calibration process referred to “determination of adjustment rate that minimizes absolute percent difference”, the Euclidian distance measure of difference between each subject and its most similar comparable is retained for summarization. At the completion of the phase the median, mean, standard deviation, minimum and maximum of the measure of similarity (Euclidian distance) is computed and displayed. Since the similarity measure (i.e., actual dollar adjustment) will always be positive and the minimum possible value will be zero, the range between the minimum and median represent a good indication of where the typical amount of adjustment (measure of similarity) will occur. The similarity index factor is determined by dividing the range between the minimum and median measures of similarity by 3. Conveniently, the similarity index is then computed by the following formula:

Similarity Index=11−(Similarity Measure/Similarity Index Factor)

Any value greater than 10 is set equal to 10 (maximum expected similarity) and any value less than 1 (minimum expected similarity) is set equal to 1. Thus the similarity index has a range from 1 to 10.

When performing an appraisal it is quite common for the appraiser to be required to summarize the appraisal on a standard form provided by either the lender or a government agency. These forms generally contain summary information contained on the output report, such as each comparables adjusted sales price, but also require the appraiser to provide judgmentally based information as well. For example, the appraiser may be required to check a box indicating if the subject is typical for its neighborhood and if not provide a description of the unusual condition of the subject.

To facilitate the combining of judgmentally based information with the documentation of the adjustment process, resulting in the value estimate for the subject, the invention has created a forms generator component to its process. A user need only select the “complete forms input elements” option and the available information from the valuation process is transferred onto a selected forms generator. A user simply completes filling in the form and can then print the form and/or e-mail the completed form the client.

In many instances an institutional user may not want their employees to have full access to all program functions. The concern may be due to lack of experience or training of users or it may be conditioned simply by not wanting employees to “perform as appraisers”. Whatever the reason, the need is to limit access to various program functions. Access to the valuation process is controlled through multiple levels. As the access level increases, so does the level of flexibility, allowing users to interact with the level of detail they desire and/or are qualified to perform. The inventive method establishes different levels of user access. In a preferred embodiment five (5) levels of user access can be established. The first three levels (level 1-3) focus on operational functions of the program while the last two levels (levels 4-5) focus on policy rules that control program operation and reporting. User level functionality can be described generally as follows:

### Level-1

Following log-on, state selection, county selection, and subject property selection, the user will supply any specialized user identification, any test value estimate, and submit the property for analysis. The output that this level of user receives is limited to:

Subject Property Value Estimate and Valuation Range

Subject Property Identification

Unusual Subject Property Characteristics

Final Comparable Sales Selected

Quality Scores

### Level-2

In addition to the level-1 controls, this user will be able to modify the as-of-date of the analysis, modify the date range for comparable search, modify the geography for the search, update the physical attribute inventory of the subject, select the rerun option and apply automatic filtering of specified attributes. The output for this level includes all of level-1 plus the following:

Final Comparable Sales Selected with mapping option

Final Comparable Sales Attribute Listing

Available Sales Profile

Available Sales Price Distribution

### Level-3

In addition to the level-2 controls, this user will be able to modify the sale condition score of the subject property and apply user specific attribute filtering. This user has full Run Time Functionality control, including the ability to redirect the selection and final weighting of the comparables used for pricing the subject property. The output for this level includes all of level-2 plus the following:

Most Similar Sales

Final Sales Adjustment Detail

Attribute Summary for Most Similar Sales

Attribute Adjustment Summary for Most Similar Sales

### Level-4

This level of user has full Run Time Functionality control plus limited access to policy and function controls. The policy controls that this level manages directly controls the operation of the valuation model but does not impact the areas of review (quality scoring) or measures of market dynamics (attribute adjustment rates or automatic time adjustment). The policy controls available are as follows:

Number of final most similar sales

Number of final sales to use for final valuation

Multiplier of final most similar sales

Minimum number of most similar sales to process

Test for Subject

Minimum sale price to assessed ratio

Maximum sale price to assessed ratio

Adjust for time indicator

Specified adjustment for time

This level of user also has access to two of the functional controls that are used to manage report content and initial comparable elimination. The functional controls available are as follows:

Attribute Display

Primary Attribute Filter Control.

### Level-5

This level of user has full control of how the valuation model operates, how the model reviews the results of the analysis and even measures of market dynamics. This level of user meets or exceeds all necessary conditions of use as set forth in the Uniform Standards of Professional Appraisal Practice (USPAP) Advisory Opinion (AO-18) regarding appraiser use of Automatic Valuation Models.

Linking the enhanced database to GIS technology allows for the ability to produce database products such as maps and reports. Maps at various scales can be derived from attributes and attribute combinations contained within the invention's geocoded parcel file. Specific map examples include:

Median (or Average) Sale Price per Block Group

Median (or Average) Sale Price per Square Foot per Block Group

Value Trends per Block Group—displaying the rate of increase or decrease over a specific period of time.

Sales Frequency per Block Group—displaying the number of transactions occurring.

Time Adjustment per Block Group—displaying the actual time adjustments as determined by the market.

Block group is probably the most desirable level for mapping, because it is the smallest level of geography for which we can purchase census data. However, other levels of geography could also be used, e.g. census tracts, zip codes, etc.

Other products may include reports summarizing user-initiated database searches for properties with certain attributes or attribute combinations. Output from these search results could be sent to a spreadsheet or mapped for spatial review.

An example of such report or map is a method of determining valuation trends real estate, the method comprising the steps of:

determining the market-driven time adjustment for at least one real estate market area at a first time;

determining the market-driven time adjustment for the at least one real estate market area at least one time subsequent to the first time; and

comparing the market-driven time adjustments for the at least one real estate market area as a function of time.

Preferably, the comparison is performed by mapping the market-driven time adjustments as a function of time.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method of determining an estimated value of a subject parcel of real estate, the method comprising the steps of:
A. constructing a valuation model based on the attributes by means of statistical analysis of a database comprising records for individual parcels of real estate, wherein the records comprise attributes of the individual parcels and wherein the parcels are not owner-occupied residential real estate;
B. determining a sale condition score for the individual parcels, wherein the sale condition score is based on the statistical fit of an actual recorded sales price for the individual parcel to a sales price predicted by the valuation model based on the individual parcel attributes; and,
C. adding the sale condition to the attributes recorded for the respective individual parcels.

2. The method of claim 1 wherein the individual parcels of real estate comprise the subject parcel.

3. The method of claim 1 wherein the database comprises records for the majority of individual parcels of real estate located within a selected territory comprising the subject parcel.

4. The method of claim 3 wherein the selected territory is the county or municipality comprising the subject parcel.

5. The method of claim 1 wherein a default value is assigned as the sale condition score for an individual parcel if no sales price information is available for the parcel.

6. The method of claim 1, wherein the database comprises enhanced records.

7. The method of claim 6 wherein the database of enhanced records is compiled by a process comprising the steps of:
(i) obtaining records of the individual real estate parcels, wherein the records comprise attributes of the individual real estate parcels;
(ii) checking the records for errors and/or missing information;
(iii) correcting the records by replacing missing or incorrect values with statistically estimated replacement values;
(iv) enriching the corrected records by adding additional attributes; and
(v) creating derived attributes for the individual real estate parcels by modeling the enriched records.

8. The method of claim 7, wherein the compiling process further comprises the steps of:
(vi) identifying the individual real estate parcels by respective geocode reference; and
(vii) correlating the individual real estate parcels to the Census Tract and Block Group which contains the respective individual real estate parcel by means of the geocoding reference.

9. The method of claim 8 wherein the replacement values are statistically estimated based on the attributes of individual parcels located in the same region as the parcel having missing and/or incorrect information.

10. The method of claim 9 wherein the region is selected from the group consisting of census geography, block, block group, borough, tract, traffic analysis zone, consolidated metropolitan statistical area, metropolitan statistical area, census metropolitan area, census agglomeration, statistical division, statistical subdivision and detailed statistical region.

11. The method of claim 1, further comprising the steps of:
D. selecting potentially similar comparable transactions by means of searching the database on the basis of the subject parcel attributes;
E. determining an attribute score for each of the potentially similar comparable transactions;
F. selecting the most similar comparable transactions based on the attribute scores;
G. adjusting the sales price of each of the most similar comparable transactions by applying attribute value adjustments and/or time value adjustments; and
H. determining the estimated value of the subject parcel on the basis of the adjusted sales price of the most similar comparable transactions.

12. The method of claim 11, wherein selecting potentially similar comparable transactions further comprises applying attribute filters.

13. The method of claim 11, wherein any of the most similar comparable transactions may be replaced by alternative comparable transactions.

14. The method of claim 11, wherein the attribute value adjustments are determined from statistical modeling of the database.

15. The method of claim 11, wherein the time value adjustments are determined from statistical modeling of the database.

16. The method of claim 11, wherein the attribute adjustment rates are calibrated.

17. The method of claim 11 further comprising the step of determining a quality score based on the similarity of the attributes of the most similar comparative transactions which were used to estimate the value of the subject parcel to the attributes of the subject parcel.

18. The method of claim 17 further comprising the step of creating a report.

19. The method of claim 18 further comprising the step of creating a map showing the locations of the subject property and the most similar comparative transactions which were used to estimate the value of the subject parcel.

20. The method of claim 19 further comprising the step of exporting the report and the map.

21. The method of claim 1 wherein the attributes include at least one of location relative to major thoroughfares, distance to the nearest stores, distance to schools, social/economic status of the neighborhood, fireplaces, garage, square footage, square footage per room, condition, number of bathrooms, view, location relative to flood plains or soil conditions.

22. The method of claim 11 wherein a prechosen value can be substituted for a determined value and/or a different comparable transaction can be substituted for at least one comparable transaction used to estimate the value of the subject parcel.

23. The method of 22 wherein different levels of access are provided to the substitutions of 22.

24. The method of claim 11 wherein a special condition attribute is attached to the subject parcel record.

25. The method of claim 13 wherein a similarity index is determined for each comparable.

26. A method of determining an estimated value of a subject parcel of real estate, the method comprising the steps of:
A. determining market derived attribute adjustment values by means of statistical analysis of a database comprising records for individual parcels of real estate, including the subject parcel, within a territory comprising the subject parcel, wherein the records comprise attributes of the individual parcels and wherein the parcels are not owner-occupied residential real estate; and
B. adjusting recorded actual sales prices for individual parcels by applying selected attribute adjustment values to the sales price, wherein the applied attribute adjustment values are selected based on a comparison of the attributes of the subject parcel and the attributes of the respective individual parcels.

27. The method of claim 26 wherein the database comprises enhanced records.

28. The method of claim 27 wherein the database of enhanced records is compiled by a process comprising the steps of:
(i) obtaining records of the individual real estate parcels, wherein the records comprise attributes of the individual real estate parcels;
(ii) checking the records for errors and/or missing information;
(iii) correcting the records by replacing missing or incorrect values with statistically estimated replacement values;
(iv) enriching the corrected records by adding additional attributes;
(v) creating derived attributes for the individual real estate parcels by modeling the enriched records; and
(vi) adding the derived attributes to the enriched records.

29. The method of claim 28 wherein the derived attributes comprise a geocode reference.

30. The method of claim 28 wherein the replacement values are statistically estimated based on the attributes of individual parcels located in a region comprising the parcel having missing and/or incorrect information.

31. The method of claim 30 wherein the region is selected from the group consisting of census geography, block, block group, borough, tract, traffic analysis zone, consolidated metropolitan statistical area, metropolitan statistical area, census metropolitan area, census agglomeration, statistical division, statistical subdivision and detailed statistical region.

32. The method of claim 26, further comprising the steps of:
D. selecting potentially similar comparable transactions by means of searching the database on the basis of the subject parcel attributes;
E. determining an attribute score for each of the potentially similar comparable transactions;
F. selecting the most similar comparable transactions based on the attribute scores; and
G. determining the estimated value of the subject parcel on the basis of the adjusted sales price of the most similar comparable transactions.

33. The method of claim 32, wherein selecting potentially similar comparable transactions further comprises applying attribute filters.

34. The method of claim 32, wherein any of the most similar comparable transactions may be replaced by alternative comparable transactions.

35. The method of claim 26, wherein the attribute adjustment rates are calibrated.

36. The method of claim 32 further comprising the step of determining a quality score based on the similarity of the attributes of the most similar comparative transactions which were used to estimate the value of the subject parcel to the attributes of the subject parcel.

37. The method of claim 36 further comprising the step of creating a report.

38. The method of claim 37 further comprising the step of creating a map showing the locations of the subject property and the most similar comparative transactions which were used to estimate the value of the subject parcel.

39. The method of claim 38 further comprising the step of exporting the report and the map.

40. The method of claim 26 wherein the attributes include at least one of location relative to major thoroughfares, distance to the nearest stores, distance to schools, social/economic status of the neighborhood, fireplaces, garage, square footage, square footage per room, condition, number of bathrooms, view, location relative to flood plains or soil conditions.

41. The method of claim 32 wherein at least one attribute adjustment value is preset as a constant prior to determining the remaining attribute adjustment rates by means of statistical analysis.

42. The method of claim 32 wherein a prechosen value can be substituted for a determined value and/or a different comparable transaction can be substituted for at least one comparable transaction used to estimate the value of the subject parcel.

43. The method of 42 wherein different levels of access are provided to the substitutions of 42.

44. The method of claim 32 wherein a special condition attribute is attached to the subject parcel record.

45. The method of claim 32 wherein a similarity index is determined for each comparable.

46. A method of determining an estimated value of a subject parcel of real estate, the method comprising the step of compiling a database comprising enhanced records for substantially all of individual parcels of real estate in a territory which comprises the subject parcel, wherein the enhanced records comprise recorded attributes and derived attributes of the individual parcels and wherein the parcels are not owner-occupied residential real estate.

47. The method of claim 46 wherein the individual parcels comprise the subject parcel.

48. The method of claim 46 wherein the database of enhanced records is compiled by a process comprising the steps of:
(i) obtaining records of the individual real estate parcels, wherein the records comprise attributes of the individual real estate parcels;
(ii) checking the records for errors and/or missing information;
(iii) correcting the records by replacing missing or incorrect values with statistically estimated replacement values;
(iv) enriching the corrected records by adding additional attributes;
(v) creating derived attributes for the individual real estate parcels by modeling the enriched records; and
(vi) adding the derived attributes to the enriched records.

49. The method of claim 48, wherein the compiling process further comprises the steps of:
(vii) identifying the individual real estate parcels by respective geocode reference; and
(viii) correlating the individual real estate parcels to the Census Tract and Block Group which contains the respective individual real estate parcel by means of the geocoding reference.

50. The method of claim 48 wherein the replacement values are statistically estimated based on the attributes of individual parcels located in the same region as the parcel having missing and/or incorrect information.

50. The method of claim 50 wherein the region is selected from the group consisting of Census Geography, Block, Block group, borough, tract, traffic analysis zone, consolidated metropolitan statistical area, metropolitan statistical area, census metropolitan area, census agglomeration, statistical division, statistical subdivision and detailed statistical region.

52. A method for preparing a database of enhanced records for individual parcels of real estate, wherein the parcels are not owner-occupied residential real estate, the method comprising the steps:
A. identifying the individual parcels by the corresponding geocoding references;
B. correlating the individual parcels to their respective Census Tracts and Block Groups by means of the geocoding reference;
C. obtaining records for the individual parcels;
D. checking the records for errors and/or missing information;
E. correcting the records by replacing missing or incorrect values with statistically estimated values for the geographic area in which the respective individual parcels are located;
F. adding additional attributes to the records to create an enriched record file;
G. modeling the enriched record file to develop derived attributes for the individual parcels; and
H. adding the derived attributes to the records of the respective individual parcels.

53. The method of claim 52 wherein the individual parcels comprise substantially all of individual parcels of real estate in a territory.

54. The method of claim 53 wherein the territory is a county or municipality.

55. The method of claim 54 wherein the territory is expanded if the number of individual parcels is less than a preselected number.

56. A method of determining the estimated value of a subject parcel of real estate, wherein the parcels are not owner-occupied residential real estate, the method comprising the steps of:
A. providing a computer, wherein the computer is connected to at least one input device and at least one output device and is capable of accessing, reading and executing real estate valuation software;
B. inputing data comprising a unique location corresponding to the parcel into the computer;
C. executing the real estate valuation software program to obtain at least one result based on the input data, the result being in the form of an estimated value for the parcel; and
D. communicating the value of the parcel obtained in Step C by means of the output device, wherein the real estate valuation software comprises computer readable and executable instructions for performing at least the following functions:
(i) compiling a database of records of individual parcels comprising the subject parcel, wherein the records comprise attributes of the individual parcels;
(ii) assigning appropriate geocodes to the individual parcels;
(iii) correlating the subject parcel and the comparable properties to respective Census Tracts and Census Blocks by means of the respective geocodes;
(iv) modeling the database to determine market-driven attribute adjustment values;
(v) selecting the most similar comparable properties, wherein the comparable properties are individual parcels having attributes similar to the subject parcel; and,
(vi) calculating an estimated value of the parcel on the basis of the selected comparable properties.

57. A real estate valuation apparatus comprising:
A. A computer operatively connected to at least one input device and at least one output device, and
B. at least one real estate valuation software program which executes at least the following functions:
(i) compiling a database of records of individual parcels of real estate comprising the subject parcel, wherein the records comprise attributes of the individual parcels and wherein the parcels are not owner-occupied residential real estate;
(ii) assigning appropriate geocodes to the individual parcels;
(iii) correlating the subject parcel and the comparable properties to respective Census Tracts and Census Blocks by means of the respective geocodes;
(iv) modeling the database to determine market-driven attribute adjustment values;
(v) selecting the most similar comparable properties, wherein the comparable properties are individual parcels having attributes similar to the subject parcel; and,
(vi) calculating an estimated value of the parcel on the basis of the selected comparable properties.
wherein the computer has access to and can execute the software program.

58. A method of determining the market-driven time adjustment to apply to a sales price of a previous real estate transaction, wherein the parcels are not owner-occupied residential real estate, the method comprising the steps:
compiling the enriched database of claim 52; and
analyzing the database by means of statistical models to determine a market-driven time adjustment for use in adjusting sales prices of comparable transactions.

59. A method of determining spatial distribute of at least one attribute of real estate, wherein the parcels are not owner-occupied residential real estate, the method comprising the steps of:
compiling the enriched database of claim 52;
analyzing the database by statistical methods to determine average or medium value of the attribute within at least designated geographic area; and
reporting the average or median attribute value for all analyzed geographic areas.

60. The method of claim 59 wherein the report is a spreadsheet or a map.

61. The method of claim 59 wherein the attribute is selected from the group consisting of sale price, sale price per square foot, sales frequency and time adjustment.

62. A method of determining value trends of real estate, the method comprising the steps of:
determining the market-driven time adjustment by means of the method of claim 51 for at least one real estate market area at a first time;
determining the market-driven time adjustment by means of the method of claim 51 for the at least one real estate market area at least one time subsequent to the first time; and
comparing the market-driven time adjustments for the at least one real estate market area as a function of time.

63. The method of claim 62 wherein the comparison is performed by mapping the market-driven time adjustments as a function of time.
